(19) United States
(12) Patent Application Publication
(10) Pub. No.: US 2026/0010200 A1
(43) Pub. Date: Jan. 8, 2026

(54) WEARABLE ELECTRONIC DEVICE INCLUDING ANTENNA AND CONDUCTIVE ELASTIC MEMBER

(71) Applicant: SAMSUNG ELECTRONICS CO., LTD., Suwon-si (KR)

(72) Inventors: Jinwoo KIM, Suwon-si (KR); Yongjun CHOI, Suwon-si (KR); Taesan KIM, Suwon-si (KR); Hyunwoo KIM, Suwon-si (KR)

(73) Assignee: SAMSUNG ELECTRONICS CO., LTD., Suwon-si (KR)

(21) Appl. No.: 19/224,037

(22) Filed: May 30, 2025

Related U.S. Application Data
(63) Continuation of application No. PCT/KR2025/006606, filed on May 15, 2025.

(30) Foreign Application Priority Data
Jul. 2, 2024 (KR) 10-2024-0086749
Aug. 1, 2024 (KR) 10-2024-0102641

(51) Int. Cl. G06F 1/16; G06F 1/18; H01Q 1/22

(52) U.S. Cl. CPC G06F 1/163; G06F 1/1637; G06F 1/1686; G06F 1/183; G06F 1/189; H01Q 1/2266

(57) ABSTRACT

A wearable electronic device according to various embodiments of the disclosure may include a first conductive housing including a first opening, a second conductive housing under the first conductive housing, a non-conductive housing surrounding at least a part of the second conductive housing and including a second opening and a third opening, a circuit board under the non-conductive housing and including an antenna power feeder, a first conductive elastic member configured to connect the first conductive housing and the antenna power feeder through the second opening, and a second conductive elastic member configured to connect the first conductive housing and the second conductive housing through the third opening. Various other embodiments may be provided.

### CROSS-REFERENCE TO RELATED APPLICATIONS

This application is a bypass continuation of International Application No. PCT/KR2025/006606, filed on May 15, 2025, which claims priority to Korean Application No. 10-2024-0086749, filed in the Korean Intellectual Property Office on Jul. 2, 2024, and Korean Application No. 10-2024-0102641, filed in the Korean Intellectual Property Office on Aug. 1, 2024, the disclosures of which are incorporated herein by reference in their entireties.

### BACKGROUND

### 1. Field

Various embodiments of the disclosure relate to a wearable electronic device including an antenna and at least one elastomeric member.

### 2. Description of Background Art

The use of electronic devices such as bar-type, foldable-type, rollable-type, or sliding-type smartphones or tablet personal computers (PCs) is increasing.

The electronic devices are being developed into wearable forms capable of being worn on body parts of users for portability and accessibility.

The wearable electronic devices may include, for example, a watch that the users are able to wear on their wrists and/or ankles.

### SUMMARY

A wearable electronic device (e.g., a watch) capable of being worn a wrist of a user may transmit and receive a variety of data to and from other electronic devices (e.g., smartphones) using wireless communication.

The wearable electronic device may include at least one antenna (e.g., a conductive housing or an antenna radiator) to perform wireless communication with other electronic devices.

For example, the wearable electronic device may use a C-clip to electrically connect a conductive housing and a power feeder of a printed circuit board. In the case where the conductive housing and the power feeder of the printed circuit board are connected using the C-clip, the contact area of the C-clip may reduce the space for arranging other electronic components on the printed circuit board.

For example, in the case where the conductive housing and the power feeder of the printed circuit board are connected using the C-clip, the radiation performance of the conductive housing used as an antenna may deteriorate due to the influence of other electronic components or electrical objects disposed adjacent to the conductive housing.

For example, if the design of the wearable electronic device and the arrangement structure of the conductive housing are determined, it may be impossible to adjust the electrical length of the conductive housing used as the antenna, so it may be difficult to improve the radiation performance of the antenna.

Various embodiments of the disclosure may provide a wearable electronic device capable of electrically connecting a power feeder formed on a circuit board (e.g., a printed circuit board) and a conductive housing (e.g., an antenna radiator) using a conductive elastic member (e.g., a pogo pin).

Technical problems solved by embodiments of the disclosure are not limited to the technical problems mentioned above, and other technical problems not mentioned that are solved by embodiments of the disclosure may be clearly understood by those skilled in the art to which the disclosure pertains from the description below.

According to an embodiment of the disclosure, a wearable electronic device may be provided and include: a first conductive housing including a first opening; a second conductive housing under the first conductive housing; a non-conductive housing surrounding at least a part of the second conductive housing, the non-conductive housing including a second opening and a third opening; a circuit board under the non-conductive housing and including an antenna power feeder; a first conductive elastic member configured to connect the first conductive housing and the antenna power feeder through the second opening; and a second conductive elastic member configured to connect the first conductive housing and the second conductive housing through the third opening.

According to various embodiments of the disclosure, it is possible to expand the space for disposing other electronic components on the circuit board by electrically connecting the power feeder formed on the circuit board and the conductive housing using the first conductive elastic member (e.g., a pogo pin).

According to various embodiments of the disclosure, it is possible to expend the electrical length of the antenna by electrically connecting the first conductive housing (e.g., an outer metal housing) and the second conductive housing (e.g., an inner metal housing) using the second conductive elastic member (e.g., a pogo pin).

In addition, various effects of embodiments of the disclosure that may be directly or indirectly recognized through this document may be provided.

### BRIEF DESCRIPTION OF DRAWINGS

In connection with the description of the drawings, the same or similar reference numerals may be used for the same or similar components.

FIG. 1 is a block diagram of an electronic device in a network environment according to various embodiments of the disclosure.

FIG. 2A is a perspective view schematically illustrating a front face of a wearable electronic device according to an embodiment of the disclosure.

FIG. 2B is a perspective view schematically illustrating a rear face of the wearable electronic device of FIG. 2A according to an embodiment of the disclosure.

FIG. 3A is an exploded perspective view schematically illustrating a partial configuration of a wearable electronic device according to an embodiment of the disclosure.

FIG. 3B is a cross-sectional view schematically illustrating a part A when the wearable electronic device of FIG. 3A is assembled according to an embodiment of the disclosure.

FIG. 3C is a cross-sectional view schematically illustrating a part B when the wearable electronic device of FIG. 3A is assembled according to an embodiment of the disclosure.

FIG. 3D is a cross-sectional view schematically illustrating a part C when the wearable electronic device of FIG. 3A is assembled according to an embodiment of the disclosure.

FIG. 4 is a diagram schematically illustrating an antenna structure of a wearable electronic device according to an embodiment of the disclosure.

FIG. 5A is a diagram schematically illustrating a state in which a first conductive elastic member is inserted into a second opening of a non-conductive housing according to an embodiment of the disclosure.

FIG. 5B is a diagram schematically illustrating a state in which a first conductive housing is bonded to a part of a non-conductive housing according to an embodiment of the disclosure.

FIG. 5C is a diagram schematically illustrating a state in which a first conductive housing and a grounding part of a circuit board are connected using a first conductive elastic member according to an embodiment of the disclosure.

FIG. 6A is a cross-sectional view schematically illustrating a unidirectional first conductive elastic member disposed between a first conductive housing and a circuit board according to an embodiment of the disclosure.

FIG. 6B is a cross-sectional view schematically illustrating a bidirectional first conductive elastic member disposed between a first conductive housing and a circuit board according to various embodiments of the disclosure.

FIG. 7 is a diagram schematically illustrating a first contact portion formed on a rear surface of a first conductive housing according to an embodiment of the disclosure.

FIG. 8 is a diagram schematically illustrating a first contact portion formed on a rear surface of a first conductive housing according to various embodiments of the disclosure.

FIG. 9 is a diagram schematically illustrating a second contact portion formed on an upper surface of a circuit board according to an embodiment of the disclosure.

FIG. 10 is a diagram illustrating an embodiment of adjusting an electrical length of an antenna of a wearable electronic device according to an embodiment of the disclosure.

FIG. 11A is a diagram schematically illustrating an embodiment in which a first conductive elastic member is adjusted to a first length when a first conductive housing of a wearable electronic device has a first thickness according to an embodiment of the disclosure.

FIG. 11B is a diagram schematically illustrating an embodiment in which a first conductive elastic member is adjusted to a second length when a first conductive housing of a wearable electronic device has a second thickness according to an embodiment of the disclosure.

FIG. 11C is a diagram schematically illustrating an embodiment in which a first conductive elastic member is adjusted to a third length when a first conductive housing of a wearable electronic device has a third thickness according to an embodiment of the disclosure.

FIG. 12 is a schematic diagram illustrating a partial configuration of a wearable electronic device when viewed from a rear according to an embodiment of the disclosure.

FIG. 13 is a diagram illustrating a distance between a second conductive housing and a speaker of a wearable electronic device according to an embodiment of the disclosure.

FIG. 14A is a diagram schematically illustrating a portion of a wearable electronic device including a flexible printed circuit board (FPCB) according to a comparative embodiment.

FIG. 14B is a diagram schematically illustrating a portion of a wearable electronic device including an FPCB according to an embodiment of the disclosure.

FIG. 15A is a diagram schematically illustrating a portion of a wearable electronic device including a motor according to a comparative example.

FIG. 15B is a diagram schematically illustrating a portion of a wearable electronic device including a motor according to an embodiment of the disclosure.

### DETAILED DESCRIPTION

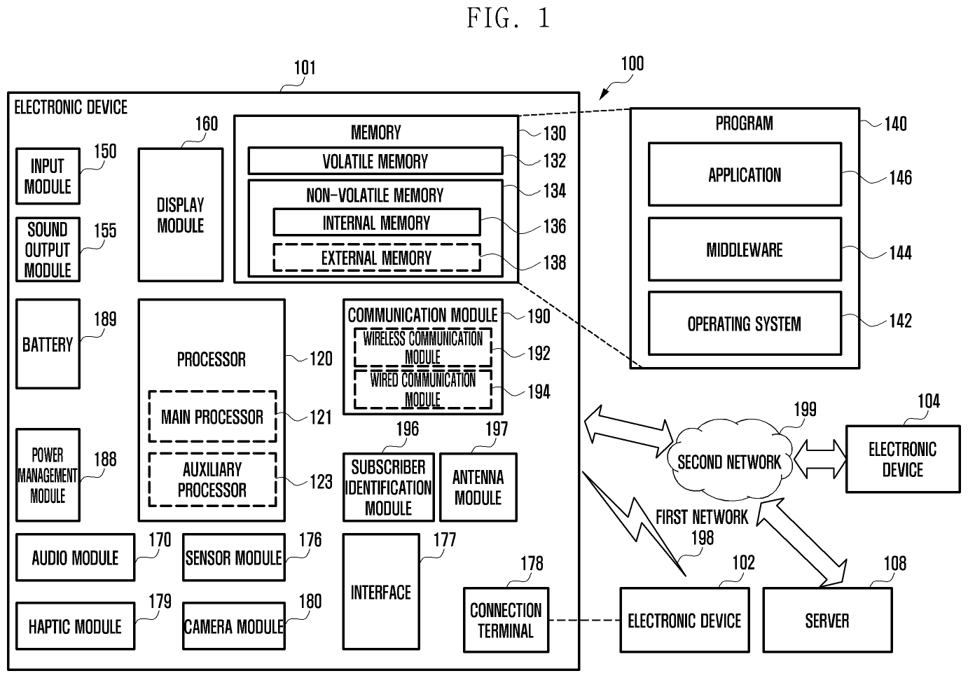

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196. The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197. The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology. According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

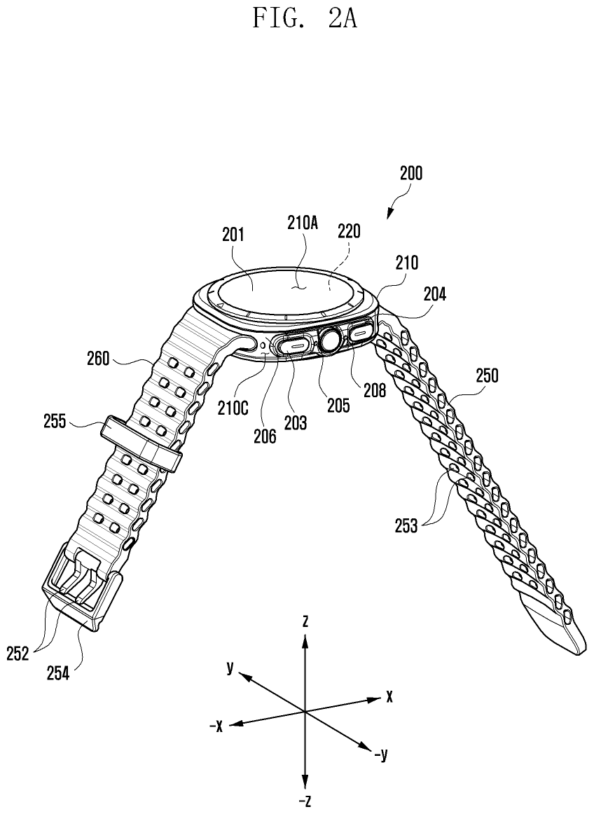

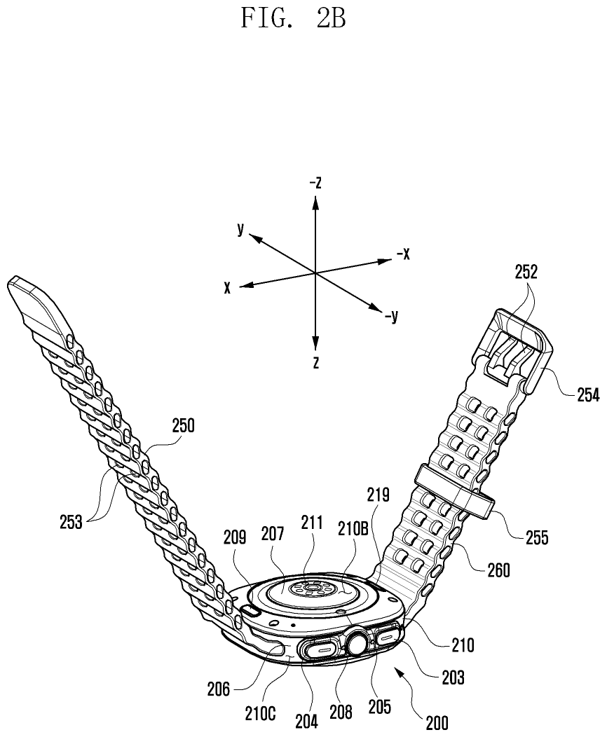

FIG. 2A is a perspective view schematically illustrating a front face of a wearable electronic device according to an embodiment of the disclosure. FIG. 2B is a perspective view schematically illustrating a rear face of the wearable electronic device of FIG. 2A according to an embodiment of the disclosure.

Referring to FIGS. 2A and 2B, a wearable electronic device 200 (e.g., the electronic device 101 in FIG. 1) may include a housing 210 including a first surface 210A (e.g., (e.g., a front surface) facing a first direction (e.g., the z-axis direction), a second surface 210B (e.g., a rear surface) facing a second direction (e.g., the −z-axis direction) opposite of the first direction, and a side surface 210C surrounding a space between the first surface 210A and the second surface 210B, and fastening members 250 and 260 connected to at least a portion of the housing 210 and configured to detachably fasten the wearable electronic device 200 to a body part (e.g., a wrist and/or an ankle) of a user.

According to an embodiment, the housing 210 may be a structure forming at least a portion of the first surface 210A (e.g., in the z-axis direction), the second surface 210B (e.g., in the −z-axis direction), and the side surface 210C. For example, the first surface 210A may be formed by a front plate 201 (e.g., a glass plate or a polymer plate including various coating layers) that is substantially transparent at least in part. For example, a display 220 (e.g., the display module 160 in FIG. 1) may be disposed below (e.g., in the −z-axis direction) of the front plate 201. For example, the second surface 210B may be formed by a rear plate 207 that may be substantially opaque. For example, the rear plate 207 may be formed of coated or tinted glass, ceramic, polymer, metal (e.g., aluminum, stainless steel (STS), or magnesium), or a combination of at least two of the above materials. For example, the side surface 210C may be formed by a side bezel structure 206 (e.g., a side member) that is coupled to the front plate 201 and the rear plate 207 and includes a conductive material (e.g., metal) and/or a non-conductive material (e.g., polymer). According to various embodiments, the rear plate 207 and the side bezel structure 206 may be formed integrally and include a conductive material and/or a non-conductive material. The fastening members 250 and 260 may be formed of various materials and shapes. For example, the fastening members 250 and 260 may be formed of woven fabric, leather, rubber, urethane, metal, ceramic, or a combination of at least two of the above materials as an integral form or multiple unit links capable of moving relative to each other.

According to an embodiment, the wearable electronic device 200 may include at least one from among a display 220, audio modules (e.g., a microphone hole 205 and a speaker hole 208), a sensor module 211, key input devices 203 and 204, attachment/detachment members 209 and 219, and fastening members 250 and 260.

According to various embodiments, the wearable electronic device 200 may exclude at least one of the above-described components (e.g., the key input devices 203 and 204, the attachment/detachment members 209 and 219, or the sensor module 211) and/or may further include other components. For example, the wearable electronic device 200 may include a connector hole. The connector hole may receive a connector (e.g., a USB connector) for transmitting and receiving power and/or data to and from an external electronic device (e.g., the electronic device 102 or 104 in FIG. 1), and may receive a connector for transmitting and receiving audio signals to and from the external electronic device. For example, the wearable electronic device 200 may further include a connector cover configured to cover at least a portion of the connector hole and prevent foreign substances from entering the connector hole.

According to an embodiment, the display 220 (e.g., the display module 160 in FIG. 1) may be exposed through at least a portion of the front plate 201. The display 220 may have various shapes, such as a circle, an oval, or a polygon, to correspond to the shape of the front plate 201. The display 220 may be combined with or disposed adjacent to a touch detection circuit, a pressure sensor capable of measuring the intensity (e.g., pressure) of a touch, and/or a fingerprint sensor.

According to an embodiment, the audio modules (e.g., the audio module 170 in FIG. 1) may include a microphone hole 205 and/or a speaker hole 208. The microphone hole 205 may have a microphone placed inside to obtain external sound. For example, a plurality of microphones may be disposed inside the microphone hole 205 to detect the direction of sound. The speaker hole 208 may be used as an external speaker and a receiver for calls. According to various embodiments, the microphone hole 205 and the speaker hole 208 may be implemented as a single hole, or a speaker (e.g., a piezo speaker) may be included without the speaker hole 208.

According to an embodiment, the sensor module 211 (e.g., the sensor module 176 in FIG. 1) may generate an electric signal or data value corresponding to an internal operating state of the wearable electronic device 200 or an external environmental state. For example, the sensor module 211 may include a biometric sensor module (e.g., a heart rate monitor (HRM) sensor) disposed on the second surface 210B of the housing 210. For example, the sensor module 211 may include at least one from among a gesture sensor, an inertial sensor, a gyro sensor, an atmospheric pressure sensor, a magnetic sensor, an acceleration sensor, a grip sensor, a color sensor, an infrared ray (IR) sensor, a biometric sensor, a temperature sensor, a humidity sensor, a hall sensor (e.g., hall IC), and an illuminance sensor.

In an embodiment, the key input devices 203 and 204 may include side key buttons positioned on the side surface 210C of the housing 210. The wearable electronic device 200 may exclude some or all of the above-described key input devices 203 and 204. For example, the key input devices 203 and 204 may be implemented in other forms, such as soft keys on the display 220.

In an embodiment, the attachment/detachment members 209 and 219 may be positioned on a portion of the housing 210 such that the fastening members 250 and 260 (e.g., a strap) may be attached to or detached from the housing 210. For example, the attachment/detachment members 209 and 219 may be disposed on the second surface 210B (e.g., the rear plate 207) of the wearable electronic device 200. For example, the attachment/detachment members 209 and 219 may include a button.

According to an embodiment, the fastening members 250 and 260 may be detachably attached to at least a portion of the housing 210 using the attachment/detachment members 209 and 219. For example, the fastening members 250 and 260 may include at least one strap. The fastening members 250 and 260 may include at least one from among a fixing member 252, a fixing member fastening hole 253, a band guide member 254, and a band fixing ring 255.

According to an embodiment, the fixing member 252 may be configured to fix the housing 210 and the fastening members 250 and 260 to a body part (e.g., wrist and/or ankle) of the user. The fixing member fastening hole 253 may fix the housing 210 and the fastening members 250 and 260 to a body part of the user so as to correspond to the fixing member 252. The band guide member 254 may be configured to prevent the fixing member 252 from moving when the fixing member 252 is fastened to the fixing member fastening hole 253, thereby causing the fastening members 250 and 260 to come into close contact with and be fastened to a body part of the user. The band fixing ring 255 may prevent the fastening members 250 and 260 from moving when the fixing member 252 and the fixing member fastening hole 253 are fastened to each other.

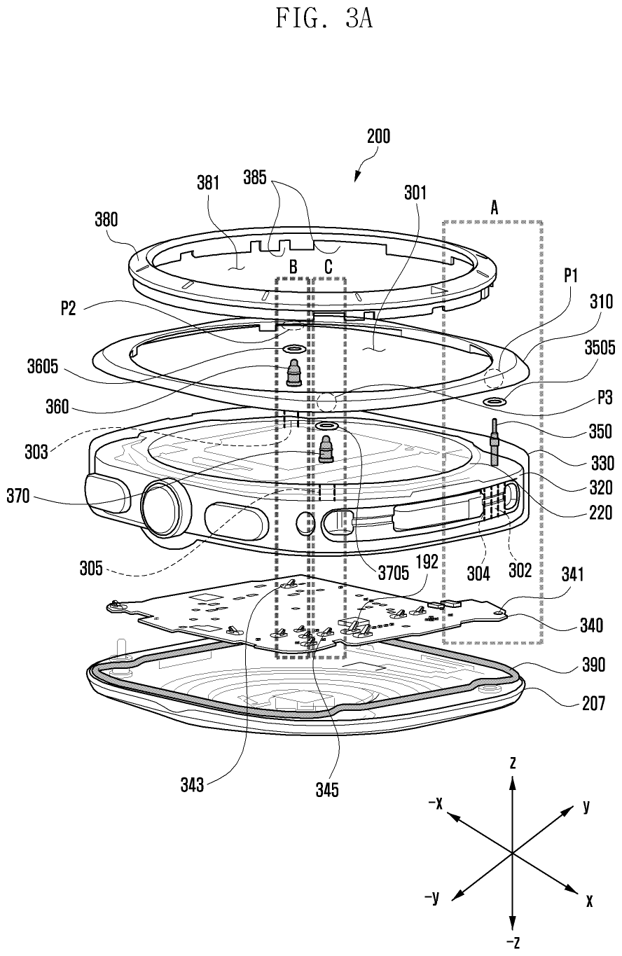

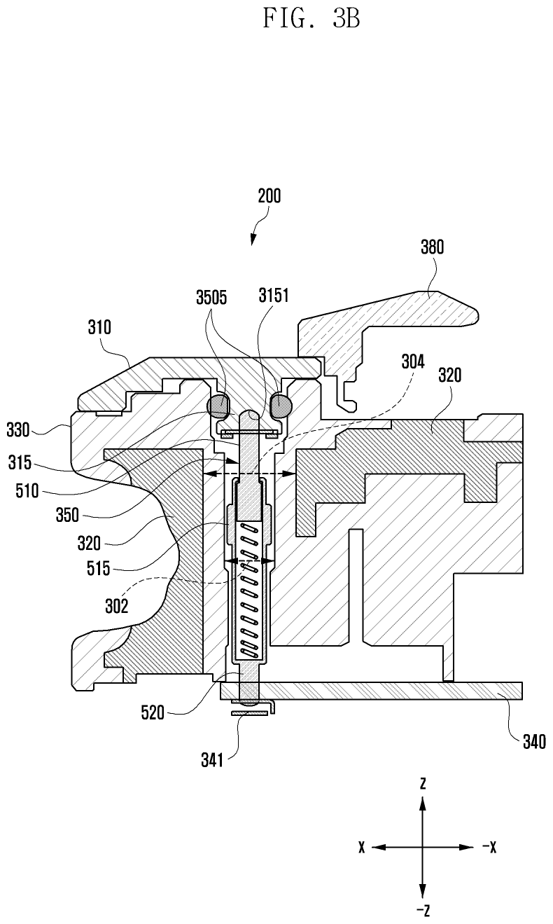

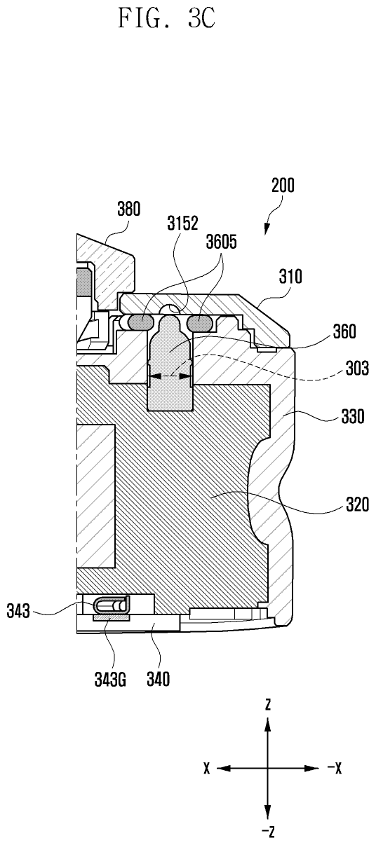

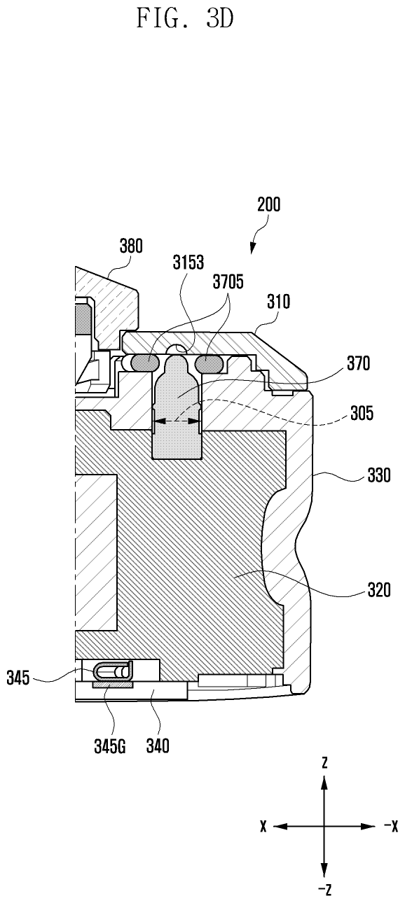

FIG. 3A is an exploded perspective view schematically illustrating a partial configuration of a wearable electronic device according to an embodiment of the disclosure. FIG. 3B is a cross-sectional view schematically illustrating a part A when the wearable electronic device of FIG. 3A is coupled according to an embodiment of the disclosure. FIG. 3C is a cross-sectional view schematically illustrating a part B when the wearable electronic device of FIG. 3A is coupled according to an embodiment of the disclosure. FIG. 3D is a cross-sectional view schematically illustrating a part C when the wearable electronic device of FIG. 3A is coupled according to an embodiment of the disclosure.

According to various embodiments, the wearable electronic device 200 of FIGS. 3A to 3D may include the electronic device 101 of FIG. 1 and at least an embodiment of the wearable electronic device 200 of FIGS. 2A and 2B. For example, the embodiments of the wearable electronic device 200 disclosed below may be substantially identically applied to the wearable electronic device 200 of FIGS. 2A and 2B. In the description of the wearable electronic device 200 disclosed below, the same reference numerals will be given to components that are substantially identical to components of the embodiments in FIGS. 1, 2A, and 2B, and redundant descriptions of their functions may be omitted.

Referring to FIGS. 3A to 3D, the wearable electronic device 200 may include a first conductive housing 310, a second conductive housing 320, a non-conductive housing 330, a circuit board 340, a first conductive elastic member 350, a second conductive elastic member 360, a third conductive elastic member 370, a third housing 380, and/or a rear plate 207.

According to an embodiment, at least some of the first conductive housing 310, the second conductive housing 320, the first conductive elastic member 350, the second conductive elastic member 360, the third conductive elastic member 370, and the third housing 380 may function as an antenna radiator of the wearable electronic device 200. For example, at least some of the first conductive housing 310, the second conductive housing 320, the first conductive elastic member 350, the second conductive elastic member 360, the third conductive elastic member 370, and the third housing 380 may function as an antenna radiator supporting frequency bands of near-field communication (NFC), Wi-Fi, 3G (generation), long-term evolution (LTE), and/or a global positioning system (GPS).

According to an embodiment, the first conductive housing 310 may have a first opening 301. For example, the first conductive housing 310 may include the first opening 301 formed therein. For example, the first conductive housing 310 may include a ring shape such as a circle, an oval, or a polygon.

According to an embodiment, a display 220 may be positioned inside the first opening 301 of the first conductive housing 310. The display 220 may be exposed to the outside through at least a portion of the first opening 301.

According to an embodiment, the second conductive housing 320 may be positioned below the first conductive housing 310 (e.g., in the −z-axis direction). At least a portion of the second conductive housing 320 may be surrounded by the non-conductive housing 330. For example, the second conductive housing 320 may include a fourth opening 304. For example, a portion of the non-conductive housing 330 may fill the fourth opening 304. For example, the non-conductive housing 330 may be formed in at least a portion inside the fourth opening 304.

According to an embodiment, the non-conductive housing 330 may surround at least a portion of the second conductive housing 320. The non-conductive housing 330 may include at least one from among a second opening 302, a third opening 303, and a fifth opening 305. For example, the second opening 302 may include a hole passing through the non-conductive housing 330 in the −z-axis direction at a corner between the x-axis direction and the y-axis direction of the non-conductive housing 330. For example, the third opening 303 may be an opening (e.g., a groove) partially formed in the −z-axis direction at a corner between the y-axis direction and the −x-axis direction of the non-conductive housing 330. For example, the fifth opening 305 may be an opening (e.g., a groove) partially formed in the −z-axis direction at a corner between the x-axis direction and the −y-axis direction of the non-conductive housing 330. For example, the second opening 302, the third opening 303, and the fifth opening 305 may be partially formed on the second conductive housing 320. According to various embodiments, the positions where the second opening 302, the third opening 303, and/or the fifth opening 305 are formed are not limited to the positions (e.g., directions) described above, and they may be formed at various positions and/or designated positions of the non-conductive housing 330 depending on the structure of the wearable electronic device 200 or the frequency of the antenna.

According to various embodiments, the fourth opening 304 formed in the second conductive housing 320 may overlap with the second opening 302 formed in the non-conductive housing 330. For example, the fourth opening 304 may have a diameter larger than the diameter of the second opening 302. For example, the second opening 302 may be located inside the fourth opening 304.

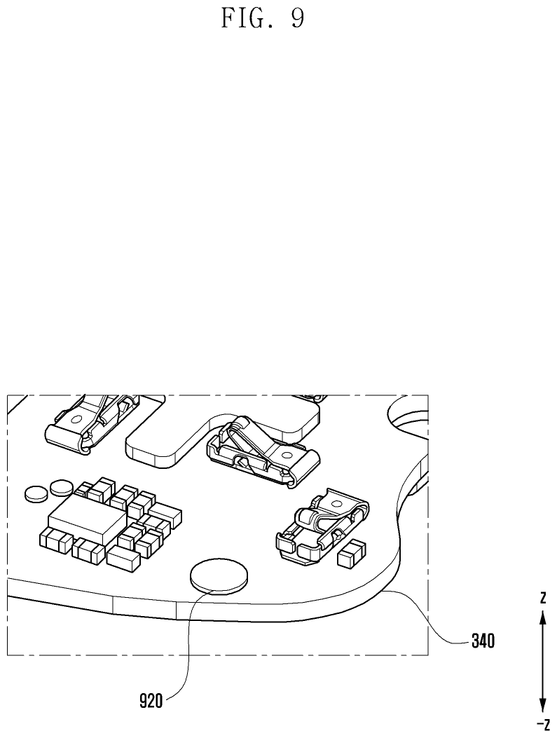

According to an embodiment, the circuit board 340 may be disposed under the non-conductive housing 330 (e.g., in the −z-axis direction). For example, the circuit board 340 may be disposed between the non-conductive housing 330 and the rear plate 207. For example, the circuit board 340 may include a printed circuit board or a flexible printed circuit board (FPCB). The circuit board 340 may include at least one from among an antenna power feeder 341, a first grounding part 343G, and a second grounding part 345G. For example, the antenna power feeder 341 may be electrically connected to a wireless communication module 192 (e.g., a radio frequency IC (RFIC)) disposed on the circuit board 340 and may transmit a wireless signal to the first conductive elastic member 350. For example, the first conductive elastic member 350 may be electrically connected to the wireless communication module 192 (e.g., a wireless communication circuit) through the antenna power feeder 341 and a power supply path formed on the circuit board 340. For example, the antenna power feeder 341 may include a second contact portion 920 of FIG. 9. For example, the antenna power feeder 341 may be formed on the second contact portion 920 of FIG. 9. For example, the first grounding part 343G may be electrically connected to a part of the second conductive housing 320 through a first C-clip 343. For example, the second grounding part 345G may be electrically connected to a part of the second conductive housing 320 through a second C-clip 345. In an embodiment, the first C-clip 343 and/or the second C-clip 345 may be replaced with other connecting members such as contact pads or conductive foam springs.

According to various embodiments, at least one from among the processor 120, the memory 130, the sensor module 176, and the interface 177 of FIG. 1 may be disposed on the circuit board 340.

According to an embodiment, the first conductive elastic member 350 may electrically connect the first conductive housing 310 and the antenna power feeder 341 through the second opening 302 formed in the non-conductive housing 330. For example, the first conductive elastic member 350 may electrically connect the first conductive housing 310 and the antenna power feeder 341 through the second opening 302 formed in the non-conductive housing 330 and the fourth opening 304 formed in the second conductive housing 320. For example, the first conductive elastic member 350 may transmit a wireless signal provided through the antenna power feeder 341 to the first conductive housing 310. For example, the first conductive elastic member 350 may include a pogo pin that is inserted and withdrawn in one direction (e.g., the z-axis direction) or in two directions (e.g., the z-axis direction and the −z-axis direction).

In an embodiment, the second conductive elastic member 360 may electrically connect the first conductive housing 310 and the second conductive housing 320 through the third opening 303 formed in the non-conductive housing 330. For example, the third opening 303 may be partially formed in the second conductive housing 320.

In an embodiment, the third conductive elastic member 370 may electrically connect the first conductive housing 310 and the second conductive housing 320 through the fifth opening 305 formed in the non-conductive housing 330. For example, the fifth opening 305 may be partially formed in the second conductive housing 320.

In an embodiment, the second conductive elastic member 360 and/or the third conductive elastic member 370 may be shorter than the first conductive elastic member 350. For example, the second conductive elastic member 360 and/or the third conductive elastic member 370 may be thicker than the first conductive elastic member 350. For example, the second conductive elastic member 360 or the third conductive elastic member 370 may have different lengths. For example, the second conductive elastic member 360 and/or the third conductive elastic member 370 may include a pogo pin that is inserted and withdrawn unidirectionally or bidirectionally. For example, the first conductive elastic member 350, the second conductive elastic member 360, and/or the third conductive elastic member 370 may include a conductive material such as gold plating, gold, or copper. According to various embodiments, the second conductive elastic member 360 and/or the third conductive elastic member 370 may be replaced with another connecting member such as a C-clip.

According to an embodiment, the first conductive housing 310 may include a first connecting portion P1 connected to the first conductive elastic member 350. For example, a portion (e.g., a first pin 510) of the first conductive elastic member 350 may be connected to the first connecting portion P1 of the first conductive housing 310. For example, the first connecting portion P1 may be a point at the bottom of the corner (e.g., in the −z-axis direction) between the x-axis direction and the y-axis direction of the first conductive housing 310.

According to an embodiment, the first conductive housing 310 may include a second connecting portion P2 connected to the second conductive elastic member 360. For example, a portion of the second conductive elastic member 360 may be connected to the second connecting portion P2 of the first conductive housing 310. For example, the second connecting portion P2 may be a point at the bottom of the corner (e.g., in the −z-axis direction) between the y-axis direction and the −x-axis direction of the first conductive housing 310.

According to an embodiment, the first conductive housing 310 may include a third connecting portion P3 connected to the third conductive elastic member 370. For example, a portion of the third conductive elastic member 370 may be connected to the third connecting portion P3 of the first conductive housing 310. For example, the third connecting portion P3 may be a point at the bottom of the corner (e.g., in the −z-axis direction) between the x-axis direction and the −y-axis direction of the first conductive housing 310.

According to an embodiment, the first connecting portion P1 of the first conductive housing 310 connected to the first conductive elastic member 350 may be positioned between the second connecting portion P2 of the first conductive housing 310 connected to the second conductive elastic member 360 and the third connecting portion P3 of the first conductive housing 310 connected to the third conductive elastic member 370. For example, the second connecting portion P2 of the first conductive elastic member 350 may be positioned between the first connecting portion P1 and the third connecting portion P3. For example, the third connecting portion P3 of the first conductive elastic member 350 may be positioned between the first connecting portion P1 and the second connecting portion P2.

According to an embodiment, the positions of the first connecting portion P1, the second connecting portion P2, and the third connecting portion P3 may be determined depending on the frequency of the antenna. For example, a first distance between the first connecting portion P1 and the second connecting portion P2 of the first conductive housing 310 may be formed longer than a second distance between the second connecting portion P2 and the third connecting portion P3. For example, the second distance between the second connecting portion P2 and the third connecting portion P3 of the first conductive housing 310 may be formed shorter than the first distance between the first connecting portion P1 and the second connecting portion P2.

According to an embodiment, the second connecting portion P2 of the first conductive housing 310, the second conductive elastic member 360, a part of the second conductive housing 320, the first C-clip 343, and the first grounding part 343C may be electrically connected, and the third connecting portion P3 of the first conductive housing 310, the third conductive elastic member 370, a part of the second conductive housing 320, the second C-clip 345, and the second grounding part 345G may be electrically connected, so that a grounding area of the first conductive housing 310 and the second conductive housing 320, which operate as antennas of the wearable electronic device 200, may be expanded.

Referring to FIG. 3B, the first conductive housing 310 may include a protrusion 315 at a position where the first conductive elastic member 350 is disposed. For example, the protrusion 315 may be formed in the −z-axis direction (e.g., bottom) of the first conductive housing 310. The protrusion 315 may be at least partially inserted into the second opening 302 formed in the non-conductive housing 330. For example, the protrusion 315 may be at least partially inserted into the fourth opening 304 formed in the second conductive housing 320.

According to an embodiment, a first sealing member 3505 may be disposed on a side surface (e.g., an outer surface) of the protrusion 315. For example, the first sealing member 3505 may be disposed on the outer surface of the protrusion 315. The first sealing member 3505 may surround the outer surface of the protrusion 315. The first sealing member 3505 may surround the side surface (e.g., the outer surface) of the protrusion 315 to prevent foreign substances from entering the interior of the non-conductive housing 330. For example, the first sealing member 3505 may include an O-ring made of rubber.

According to an embodiment, the protrusion 315 may include a first groove 3151 formed at an end (e.g., in the −z-axis direction). For example, at least a portion of the first conductive elastic member 350 (e.g., in the z-axis direction) may be inserted into the first groove 3151. For example, at least a portion (e.g., the first pin 510) of the first conductive elastic member 350 may be inserted into the first groove 3151 formed at the end of the protrusion 315 to be electrically connected to the first conductive housing 310.

Referring to FIG. 3C, in an embodiment, the first conductive housing 310 may include a second groove 3152 at a position where the second conductive elastic member 360 is disposed. For example, at least a portion of the second conductive elastic member 360 (e.g., in the z-axis direction) may be inserted and connected to the second groove 3152. For example, at least a portion of the second conductive elastic member 360 may be inserted into the second groove 3152 of the first conductive housing 310, so that the first conductive housing 310 and the second conductive housing 320 may be electrically connected.

According to an embodiment, a second sealing member 3605 may be disposed on at least a portion of a side surface (e.g., an outer surface) of the second conductive elastic member 360 inserted into the second groove 3152. The second sealing member 3605 may surround at least a portion of the side surface (e.g., the outer surface) of the second conductive elastic member 360 and prevent foreign substances from entering the interior of the non-conductive housing 330. For example, the second sealing member 3605 may include an O-ring made of rubber.

Referring to FIG. 3D, in an embodiment, the first conductive housing 310 may include a third groove 3153 at a position where the third conductive elastic member 370 is disposed. For example, at least a portion of the third conductive elastic member 370 (e.g., in the z-axis direction) may be inserted into the third groove 3153. For example, at least a portion of the third conductive elastic member 370 may be inserted into the third groove 3153 of the first conductive housing 310, so that the first conductive housing 310 and the second conductive housing 320 may be electrically connected.

According to an embodiment, a third sealing member 3705 may be disposed on at least a portion of a side surface (e.g., an outer surface) of the third conductive elastic member 370 inserted into the third groove 3153. The third sealing member 3705 may surround at least a portion of the side surface (e.g., the outer surface) of the third conductive elastic member 370 and prevent foreign substances from entering the interior of the non-conductive housing 330. For example, the third sealing member 3705 may include an O-ring made of rubber.

According to various embodiments, the third housing 380 may be disposed on the top of the first conductive housing 310 (e.g., in the z-axis direction). The third housing 380 may include a sixth opening 381 at a position corresponding to the first opening 301 of the first conductive housing 310. For example, the third housing 380 may include the sixth opening 381 formed therein. For example, the display 220 may be exposed to the outside through at least a portion of the sixth opening 381.

According to an embodiment, the third housing 380 may include a non-conductive material (e.g., polymer) and/or a conductive material (e.g., metal). The third housing 380 may not be electrically connected to the first conductive housing 310. For example, in the case where the third housing 380 is formed of a conductive material, the third housing 380 may include a cutting area 385 cut in a concave shape in the remaining portions, excluding portions to be coupled to the first conductive housing 310, in order to reduce an influence on the radiation performance of the first conductive housing 310. For example, the third housing 380 may include at least one cutting area 385 formed therein. For example, if the third housing 380 is formed of a conductive material, at least a portion of the third housing 380 may be coated with a non-conductive material.

According to various embodiments, the rear plate 207 may be disposed under the circuit board 340 (e.g., in the −z-axis direction). The circuit board 340 may be disposed between the non-conductive housing 330 and the rear plate 207. The rear plate 207 may include a fourth sealing member 390 formed along an inner edge (e.g., in the z-axis direction) of the rear plate 207. The fourth sealing member 390 may be disposed between the second conductive housing 320 or the non-conductive housing 330 and the rear plate 207, and may prevent foreign substances from entering the circuit board 340. For example, the fourth sealing member 390 may include a rubber material.

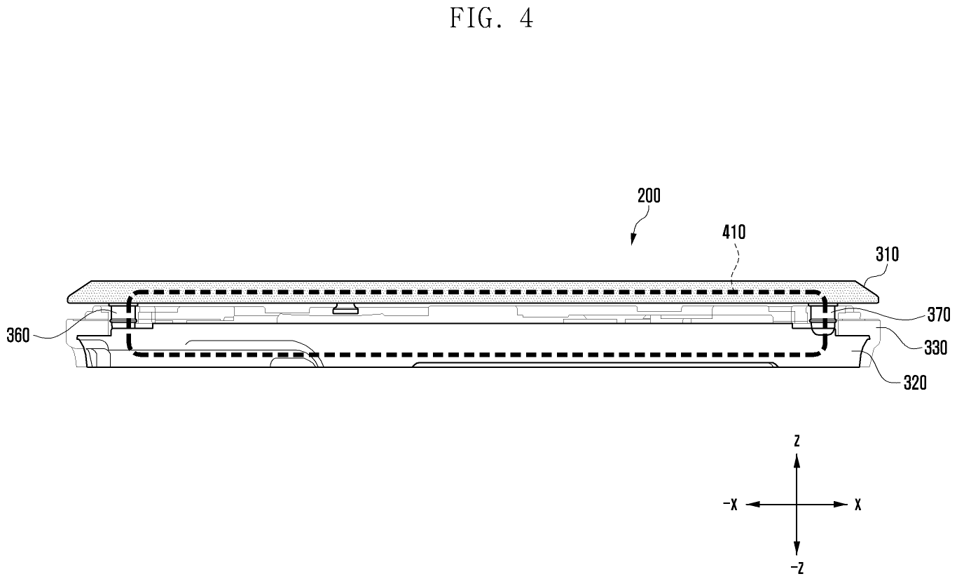

FIG. 4 is a drawing schematically illustrating an antenna structure of a wearable electronic device according to an embodiment of the disclosure.

For example, the antenna structure shown in FIG. 4 may be a schematically cross-sectional view of a part of the wearable electronic device of FIG. 3A when assembled, viewed in the −y-axis direction.

Referring to FIG. 4, the wearable electronic device 200 according to an embodiment of the disclosure may form an antenna structure.

According to an embodiment, the first conductive housing 310 and the second conductive housing 320 may be electrically connected through the second conductive elastic member 360 and/or the third conductive elastic member 370.

According to an embodiment, at least a part of a non-conductive housing 330 may be disposed between the first conductive housing 310 and the second conductive housing 320.

According to an embodiment, the first conductive housing 310 and the second conductive housing 320 may be electrically connected through the second conductive elastic member 360 and/or the third conductive elastic member 370 to form a radio frequency signal path, thereby operating as an antenna 410.

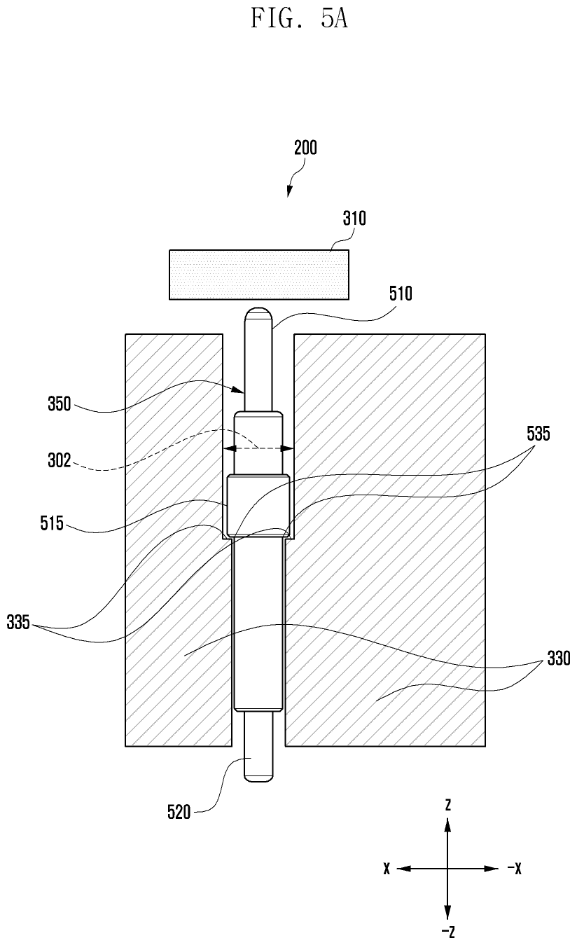

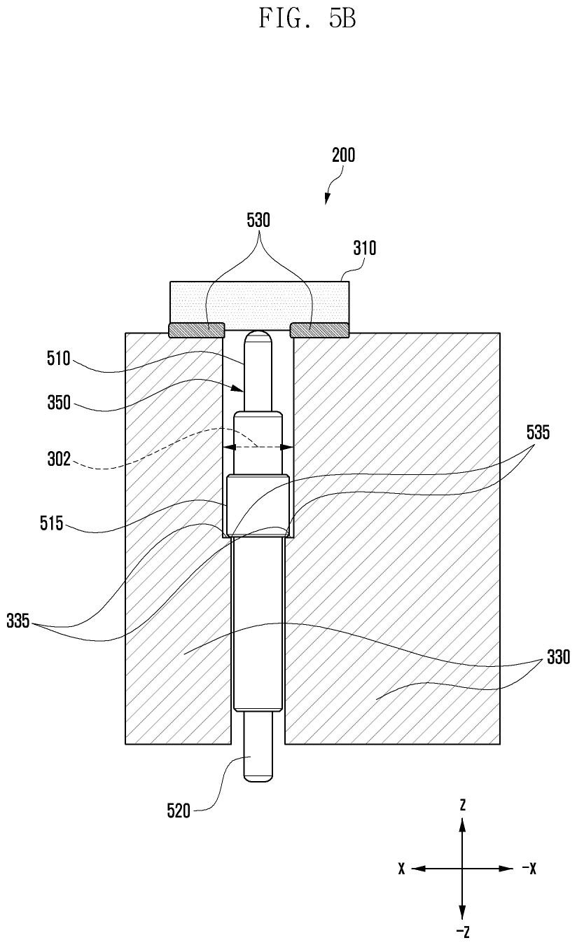

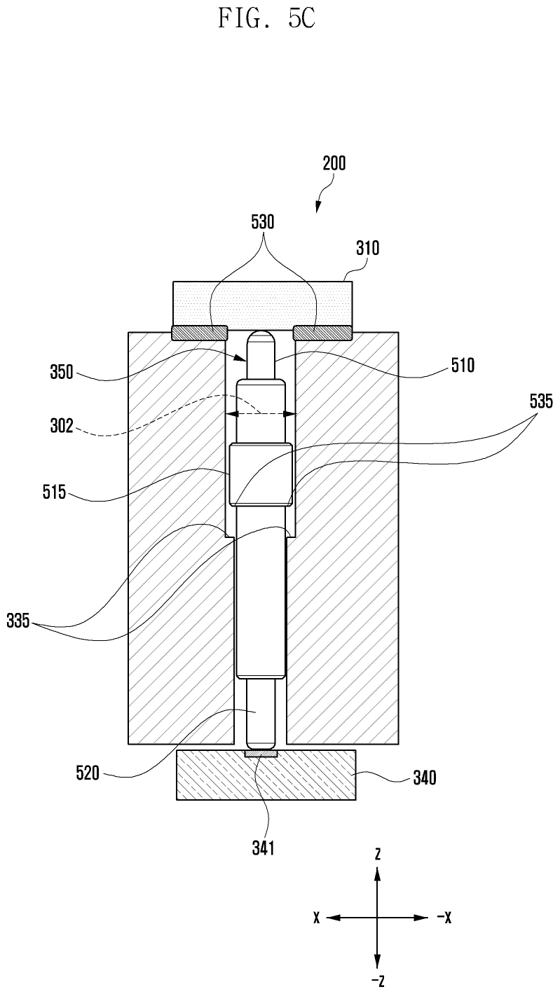

FIG. 5A is a diagram schematically illustrating a state in which a first conductive elastic member is inserted into a second opening of a non-conductive housing according to an embodiment of the disclosure. FIG. 5B is a diagram schematically illustrating a state in which a first conductive housing is bonded to a part of a non-conductive housing according to an embodiment of the disclosure. FIG. 5C is a diagram schematically illustrating a state in which a first conductive housing and a grounding part of a circuit board are connected using a first conductive elastic member according to an embodiment of the disclosure.

For example, FIGS. 5A to 5C may be drawings schematically illustrating a process of assembling the first conductive elastic member 350 to the first conductive housing 310, the second opening 302 of the non-conductive housing 330, and the circuit board 340.

Referring to FIG. 5A, the first conductive elastic member 350 may be inserted into the second opening 302 of the non-conductive housing 330. For example, the first conductive elastic member 350 may include a pogo pin that is inserted and withdrawn unidirectionally (e.g., in the z-axis direction).

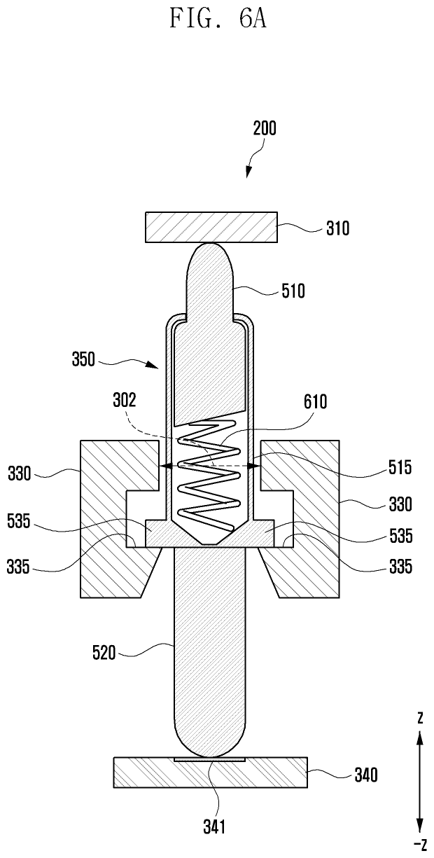

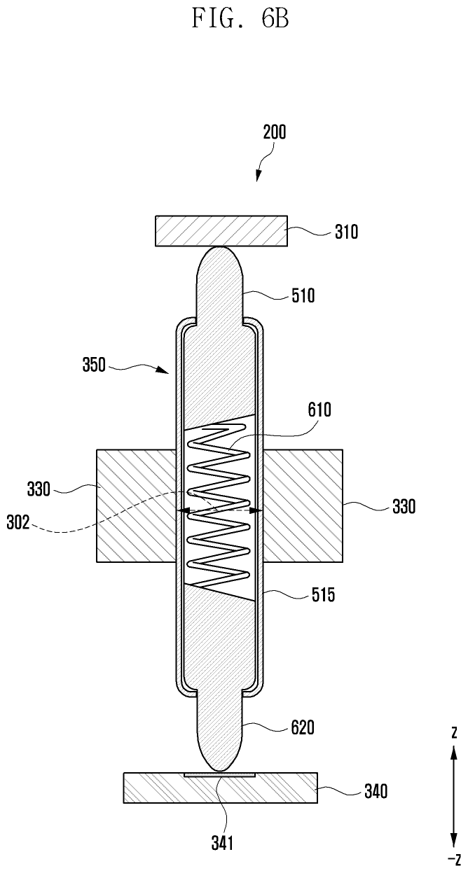

According to an embodiment, the first conductive elastic member 350 may include the first pin 510, a base member 520, and a body 515 (e.g., a tube). The first conductive elastic member 350 may include a spring (e.g., the spring 610 in FIG. 6A) inside the body 515.

According to an embodiment, the first pin 510 may be inserted into the body 515 or withdrawn from the body 515 in the z-axis direction of the first conductive elastic member 350 via the spring 610 disposed inside the body 515.

In an embodiment, the base member 520 may support the spring 610 to have elasticity.

In an embodiment, the body 515 may be disposed between the first pin 510 and the base member 520. For example, the body 515 and the base member 520 may be formed integrally. For example, the body 515 may be thicker than the first pin 510 and/or the base member 520. For example, the body 515 may include a first step 535. The first step 535 may be formed on a portion of the body 515. The first step 535 formed on the body 515 may be caught and supported by a second step 335 formed on the second opening 302 of the non-conductive housing 330. For example, the second step 335 formed on the second opening 302 of the non-conductive housing 330 may prevent the body 515 of the first conductive elastic member 350 from being separated in the second direction (e.g., the −z-axis direction) of the non-conductive housing 330.

Referring to FIG. 5B, a part of the first conductive housing 310 may be coupled to a part of the non-conductive housing 330 using an adhesive member 530. For example, a part of the first conductive housing 310 may be bonded to the top of the second opening 302 of the non-conductive housing 330 (e.g., in the z-axis direction) via the adhesive member 530. For example, the adhesive member 530 may include an adhesive, a double-sided tape, or a molding.

Referring to FIG. 5C, the circuit board 340 may be brought into contact with the lower portion of the non-conductive housing 330 (e.g., in the −z-axis direction) while the first pin 510 of the first conductive elastic member 350 is in contact with the first conductive housing 310. For example, when the first conductive housing 310 is coupled to the top of the second opening 302 (e.g., in the z-axis direction) and when the circuit board 340 is positioned under the second opening 302 (e.g., in the −z-axis direction) in the state where the first conductive elastic member 350 is inserted into the second opening 302 of the non-conductive housing 330, the first pin 510 of the first conductive elastic member 350 may be electrically connected to the first conductive housing 310 while being inserted, for example, in the −z-axis direction, and the base member 520 may be electrically connected to the antenna power feeder 341 formed on the circuit board 340.

FIG. 6A is a cross-sectional view schematically illustrating a unidirectional first conductive elastic member disposed between a first conductive housing and a circuit board according to an embodiment of the disclosure. FIG. 6B is a cross-sectional view schematically illustrating a bidirectional first conductive elastic member disposed between a first conductive housing and a circuit board according to various embodiments of the disclosure.

According to various embodiments, descriptions related to the first conductive elastic member 350 of FIGS. 6A and 6B may be applied to the first conductive elastic member 350 of FIGS. 3A and 5A to 5C described above.

Referring to FIG. 6A, in the state where the first conductive elastic member 350 according to an embodiment is inserted into the second opening 302 of the non-conductive housing 330, the first pin 510 may be connected to the first conductive housing 310, and the base member 520 may be electrically connected to the antenna power feeder 341 formed on the circuit board 340. For example, the first pin 510 of the first conductive elastic member 350 shown in FIG. 6A may be inserted into or withdrawn from the body 515 in the first direction (e.g., the z-axis direction).

According to an embodiment, the first conductive elastic member 350 shown in FIG. 6A may be formed in substantially the same manner as the embodiments shown in FIGS. 5A to 5C described above.

Referring to FIG. 6B, the first conductive elastic member 350 according to various embodiments may be inserted into the second opening 302 of the non-conductive housing 330. The first conductive elastic member 350 may include a pogo pin that is inserted and withdrawn in both directions (e.g., in the z-axis direction and the −z-axis direction).

According to various embodiments, the first conductive elastic member 350 may include the first pin 510, a second pin 620, and a body 515. The first conductive elastic member 350 may include a spring 610 inside the body 515.

According to an embodiment, the first pin 510 may be inserted and withdrawn in a first direction (e.g., the z-axis direction) via the spring 610 disposed inside the body 515.

According to an embodiment, the second pin 620 may be inserted and withdrawn in a second direction (e.g., the −z-axis direction) via the spring 610 disposed inside the body 515.

According to an embodiment, the body 515 may be disposed between the first pin 510 and the second pin 620. The body 515 may be thicker than the first pin 510 and the second pin 620.

According to various embodiments, the first pin 510, the body 515, and/or the second pin 620 may be formed integrally.

According to an embodiment, when the first conductive housing 310 is coupled to the top of the non-conductive housing 330 (e.g., in the z-axis direction) and when the circuit board 340 is positioned under the non-conductive housing 330 (e.g., in the −z-axis direction) in the state where the first conductive elastic member 350 is inserted into the second opening 302 of the non-conductive housing 330, the first pin 510 of the first conductive elastic member 350 may be electrically connected to the first conductive housing 310, and the second pin 620 may be electrically connected to the antenna power feeder 341 formed on the circuit board 340.

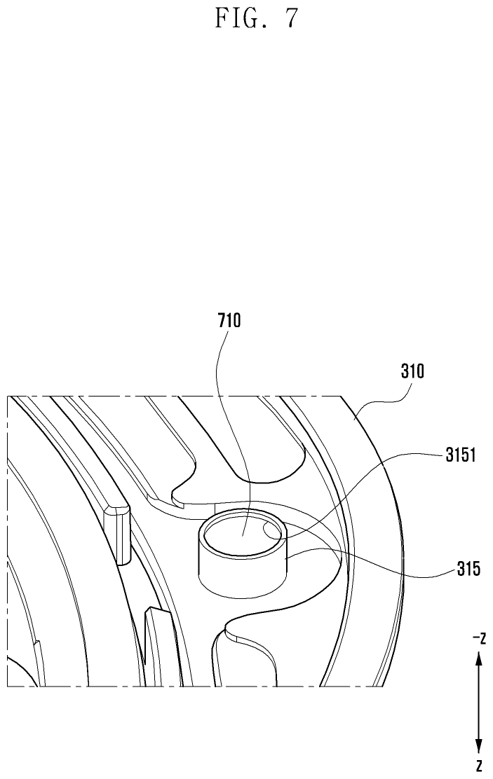

FIG. 7 is a diagram schematically illustrating a first contact portion formed on a rear surface of a first conductive housing according to an embodiment of the disclosure.

For example, FIG. 7 may be a drawing illustrating a part of a first conductive housing 310 of a wearable electronic device 200 shown in FIG. 3A when viewed from the rear (e.g., in the −z-axis direction) according to an embodiment of the disclosure.

Referring to FIG. 7, the first conductive housing 310 may have a first contact portion 710 formed inside the first groove 3151 formed in the protrusion 315. For example, the first contact portion 710 may include a conductive material including gold plating or copper plating. For example, a portion (e.g., the first pin 510) of the first conductive elastic member 350 may come into contact with the first contact portion 710. The first contact portion 710 may be formed by welding a conductive material including gold plating or copper plating using a laser beam to prevent the first conductive elastic member 350 (e.g., the first pin 510) from being corroded.

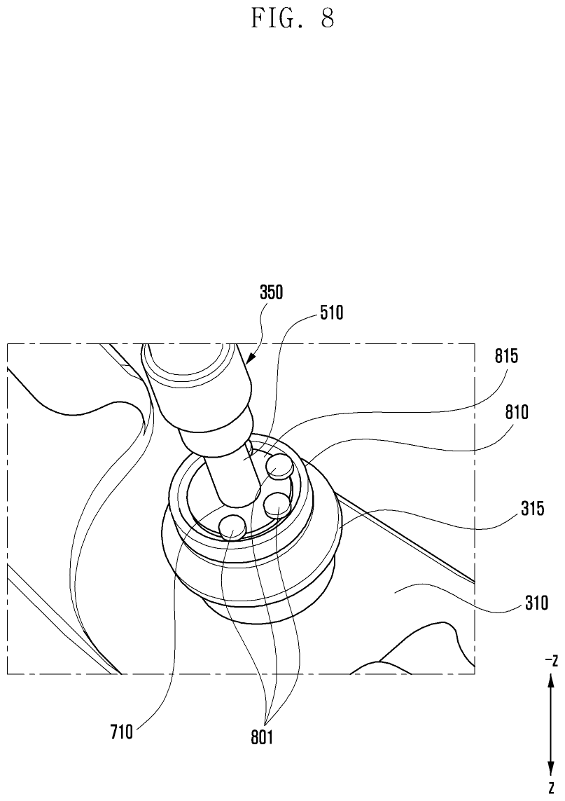

FIG. 8 is a diagram schematically illustrating a first contact portion formed on a rear surface of a first conductive housing according to various embodiments of the disclosure.

For example, FIG. 8 may be a diagram illustrating a portion of a first conductive housing 310 of a wearable electronic device 200 shown in FIG. 3A when viewed from the rear (e.g., in the −z-axis direction) according to an embodiment of the disclosure.

Referring to FIG. 8, the first conductive housing 310 may include a contact member 810 positioned at the bottom of the protrusion 315 (e.g., in the −z-axis direction). For example, the contact member 810 may include a conductive sheet 815 (e.g., a metal sheet) on which at least one gold plating 801 is formed. For example, the conductive sheet 815 may include a first contact portion 710. For example, a portion (e.g., the first pin 510) of the first conductive elastic member 350 may come into contact with the first contact portion 710. The first contact portion 710 formed on a portion of the conductive sheet 815 may prevent a portion (e.g., the first pin 510) of the first conductive elastic member 350 from being corroded.

FIG. 9 is a diagram schematically illustrating a second contact portion formed on an upper surface of a circuit board according to an embodiment of the disclosure.

For example, FIG. 9 may be a diagram illustrating a portion of a circuit board 340 of a wearable electronic device 200 shown in FIG. 3A when viewed from above (e.g., in the z-axis direction) according to an embodiment of the disclosure.

Referring to FIG. 9, the circuit board 340 may include a second contact portion 920 formed on an upper surface (e.g., in the z-axis direction). For example, the second contact portion 920 may include a conductive material including gold plating or copper plating. For example, a portion (e.g., the base member 520 or the second pin 620) of the first conductive elastic member 350 may come into contact with the second contact portion 920. The second contact portion 920 may prevent a portion (e.g., the base member 520 or the second pin 620) of the first conductive elastic member 350 from being corroded.

According to an embodiment, the antenna power feeder 341 may be formed on the second contact portion 920.

According to various embodiments, the second contact portion 920 may also be formed on the rear plate 207. For example, the second contact portion 920 may be disposed on the rear plate 207. In the case where the second contact portion 920 is formed on the rear plate 207, the first conductive elastic member 350 may penetrate the circuit board 340, so that a portion (e.g., the base member 520 or the second pin 620) of the first conductive elastic member 350 may come into contact with the second contact portion 920.

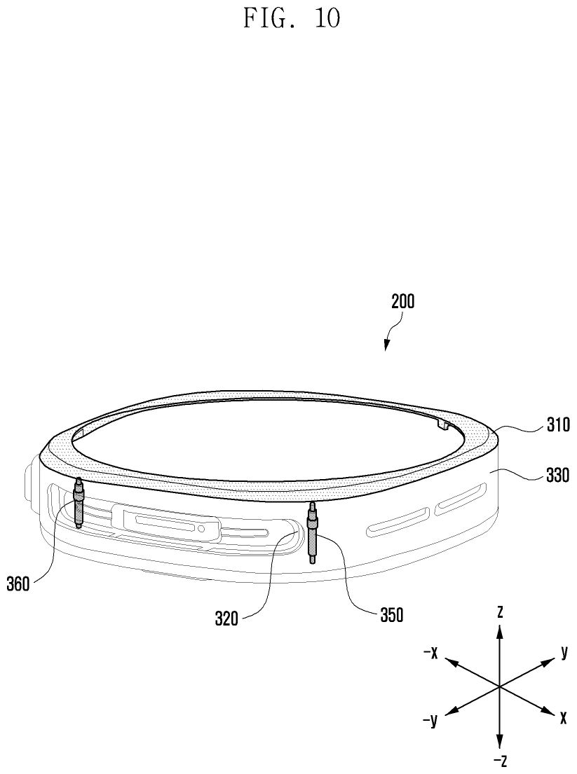

FIG. 10 is a diagram illustrating an embodiment of adjusting an electrical length of an antenna of a wearable electronic device according to an embodiment of the disclosure.

For example, the embodiments shown in FIGS. 3A to 9 may be substantially identically included in the wearable electronic device 200 shown in FIG. 10.

Referring to FIG. 10, the wearable electronic device 200 may include a first conductive housing 310, a second conductive housing 320, a first conductive elastic member 350, and/or a second conductive elastic member 360.

According to an embodiment, the first conductive housing 310 may function as an antenna radiator of the wearable electronic device 200. For example, the first conductive housing 310 may be electrically connected to an antenna power feeder 341 of a circuit board 340 using the first conductive elastic member 350. For example, the first conductive housing 310 and the second conductive housing 320 may be electrically connected using the second conductive elastic member 360 (or the third conductive elastic member 370). For example, a part of the second conductive housing 320 may be electrically connected to the first grounding part 343G formed on the circuit board 340 through the first C-clip 343.

According to an embodiment, the first conductive housing 310, the second conductive housing 320, the first conductive elastic member 350, and/or the second conductive elastic member 360 may operate as a modified planar inverted-F-type antenna.

According to an embodiment, the electrical length (Lf) of the first conductive housing 310 may be λ/4. For example, in the case where the first conductive housing 310 is electrically connected to the antenna power feeder 341 using the first conductive elastic member 350, the electrical length (Lp1) of the first conductive elastic member 350 may be added to the electrical length (Lf) of the first conductive housing 310. For example, the antenna radiator may be adjusted to an electrical length that is the sum of the electrical length (Lf) of the first conductive housing 310 and the electrical length (Lp1) of the first conductive elastic member 350. For example, in the case where the first conductive housing 310 and the second conductive housing 320 are electrically connected using the second conductive elastic member 360, and where a part of the second conductive housing 320 is electrically connected to the first grounding part 343G, the electrical length (Lp2) of the second conductive elastic member 360 may be added to the electrical length (Lf) of the first conductive housing 310 and the electrical length (Lp1) of the first conductive elastic member 350. For example, the antenna radiator may be adjusted to an electrical length that is the sum of the electrical length (Lf) of the first conductive housing 310, the electrical length (Lp1) of the first conductive elastic member 350, and the electrical length (Lp2) of the second conductive elastic member 360.

According to an embodiment, the wearable electronic device 200 may improve the radiation performance of the antenna by adjusting and/or tuning the electrical length of the antenna radiator.

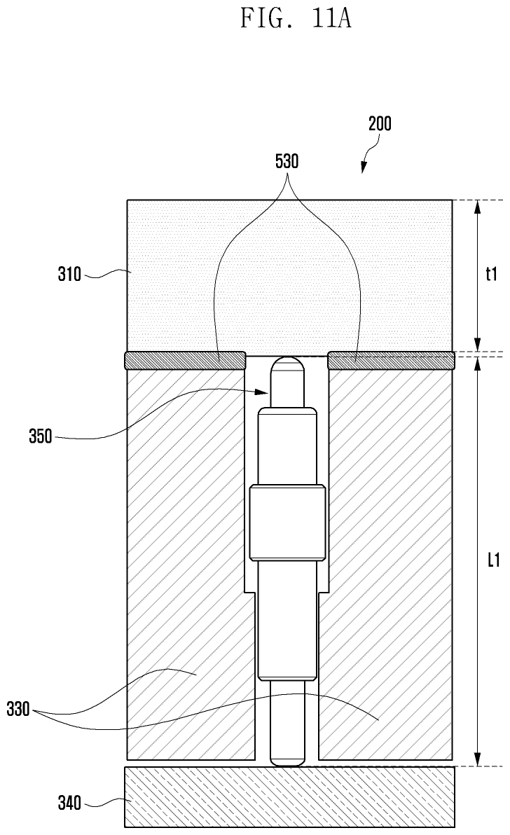

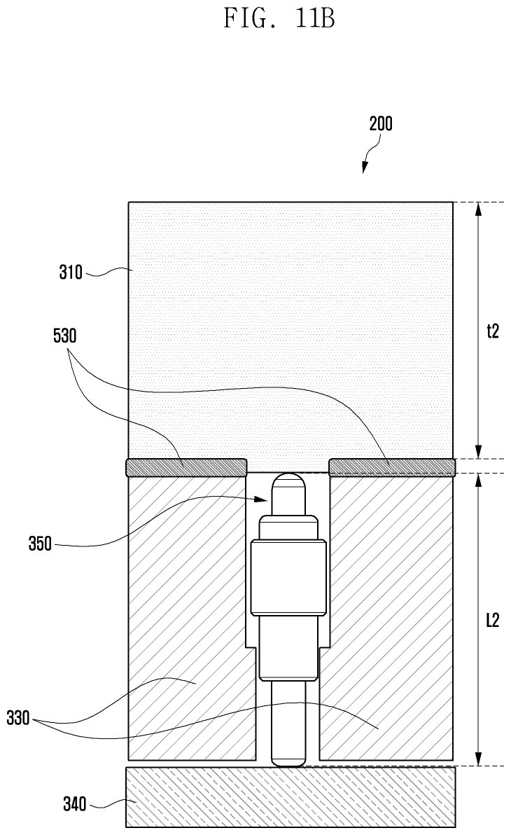

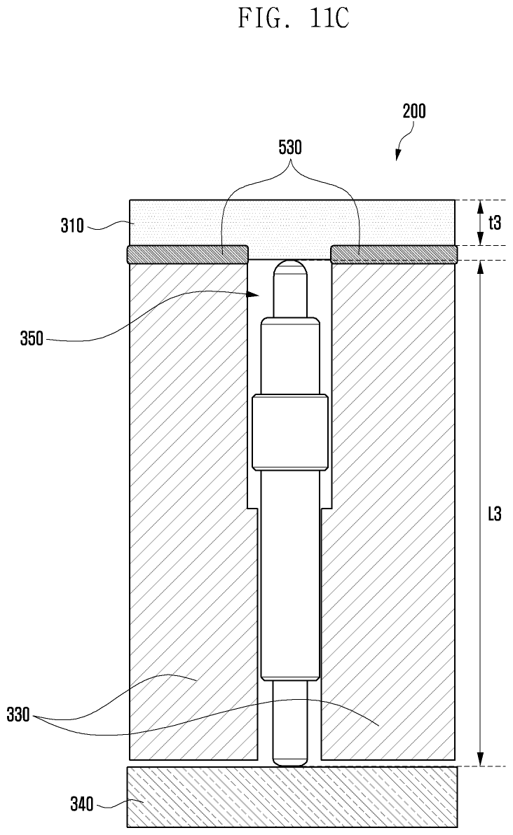

FIG. 11A is a diagram schematically illustrating an embodiment in which a first conductive elastic member is adjusted to a first length when a first conductive housing of a wearable electronic device has a first thickness according to an embodiment of the disclosure. FIG. 11B is a diagram schematically illustrating an embodiment in which a first conductive elastic member is adjusted to a second length when a first conductive housing of a wearable electronic device has a second thickness according to an embodiment of the disclosure. FIG. 11C is a diagram schematically illustrating an embodiment in which a first conductive elastic member is adjusted to a third length when a first conductive housing of a wearable electronic device has a third thickness according to an embodiment of the disclosure.

Referring to FIG. 11A, if the first conductive housing 310 is formed to have a first thickness t1, the first conductive elastic member 350 may be adjusted to have a first length L1.

Referring to FIG. 11B, if the first conductive housing 310 is formed to have a second thickness t2, the first conductive elastic member 350 may be adjusted to have a second length L2. For example, the second thickness t2 shown in FIG. 11B may be greater than the first thickness t1 shown in FIG. 11A. For example, the second length L2 shown in FIG. 11B may be less than the first length L1 shown in FIG. 11A.

Referring to FIG. 11C, if the first conductive housing 310 is formed to have a third thickness t3, the first conductive elastic member 350 may be adjusted to have a third length L3. For example, the third thickness t3 shown in FIG. 11C may be less than the first thickness t1 shown in FIG. 11A. For example, the third length L3 shown in FIG. 11C may be greater than the first length L1 shown in FIG. 11A.

According to an embodiment, the wearable electronic device 200 according to an embodiment of the disclosure may enable tuning of the electrical length of the antenna radiator by adjusting the thickness of the first conductive housing 310 and the length of the first conductive elastic member 350 even after the design is determined. According to various embodiments, the wearable electronic device 200 may enable tuning of the electrical length of the antenna radiator by adjusting the thickness of the first conductive housing 310, and the lengths of the second conductive elastic member 360 and/or the third conductive elastic member 370 even after the design is determined.

According to an embodiment, the wearable electronic device 200 may tune the resonant frequency of a wireless signal by adjusting the first conductive elastic member 350 to have, for example, a first length L1, a second length L2, or a third length L3.

According to an embodiment, if the first conductive elastic member 350 has a first length L1, the resonant frequency may be as shown in Equation 1 below.

$$Lf = 0.1382 m = 0.0069 m , Lf + L 1 = 0.1451 m , \qquad [ Equation 1 ]$$

$$Lf + L 1 = λ / 4 , λ = 0.1451 \times 4 = 0.5 \; 804 m , f = c / λ = 516 Mhz$$

For example, in Equation 1 above, Lf is the electrical length of the first conductive housing 310, L1 is the length (e.g., the first length) of the first conductive elastic member 350, and c is the speed of light.

According to an embodiment, when the first conductive elastic member 350 is reduced to a second length L2 shorter than the first length L1, the resonant frequency may shift to a high frequency as shown in Equation 2 below. For example, the first conductive elastic member 350 may be reduced by about 4 mm from the first length L1.

$$Lf = 0.1 \; 382 m , L2 = 0.0 \; 029 m , Lf + L 2 = 0.1 \; 411 m , \qquad [ Equation 2 ]$$

$$Lf + L 2 = λ / 4 , λ = 0.1411 \times 4 = 0.5 \; 6044 m , f = c / λ = 535 Mhz$$

For example, in Equation 2 above, Lf is the electrical length of the first conductive housing 310, L2 is the length (e.g., the second length) of the first conductive elastic member 350, and c is the speed of light. For example, L2 may be the second length that the first conductive elastic member 350 has, which is reduced by about 4 mm from the first length L1. When the first conductive elastic member 350 is reduced from the first length L1 to the second length L2, it can be seen that the resonant frequency shifts to a higher frequency of about 19 MHz.

According to an embodiment, as the resonant frequency shifts higher, based on a change (e.g., reduction) in the length of the first conductive elastic member 350, it can be seen that the resonant frequency moves to a low band and that the total radiated power (TRP) (transmission output) performance is improved, as shown in Table 1 below. For example, in Table 1 below, the length of the first conductive elastic member may be reduced from about 0.69 mm to about 0.29 mm.

TABLE 1

| Frequency Band | TRP | B71 | B12 | B13 | B20 | B5 | B8 |
|---|---|---|---|---|---|---|---|
| Frequency (MHz) | TRP | 680.5 | 707.5 | 782 | 847 | 836 | 897.5 |
| TRP | Improvement [dB] | 0.8 | 0.7 | 0.3 | 0.1 | 0.2 | 0 |

According to an embodiment, the wearable electronic device 200 may secure a separation distance from other electrical components (e.g., the FPCB, the speaker, or the motor) by reducing the thickness of the first conductive housing 310. According to an embodiment, it can be seen in Table 2 below that the total radiated power (TRP) (transmission output) performance is improved in the wearable electronic device in which the first conductive housing 310 and the antenna power feeder 341 of the circuit board 340 are electrically connected using the first conductive elastic member 350, instead of the C-clip according to the comparative embodiment.

TABLE 2

| Frequency Band | TRP | B71 | B12 | B13 | B20 | B5 | B8 |
|---|---|---|---|---|---|---|---|
| Frequency (MHz) | TRP | 680.5 | 707.5 | 782 | 847 | 836 | 897.5 |
| Comparative embodiment [dBm] | Difference | 1.6 | 1.2 | 1.3 | 0.7 | 1.6 | 0.6 |
| Present embodiment [dBm] | Difference | 0.7 | 0.5 | 0.5 | 0.3 | 0.8 | 0.5 |

For example, the comparative embodiment may be an embodiment in which the first conductive housing 310 and the antenna power feeder 341 of the circuit board 340 are electrically connected using a C-clip, and the present embodiment may be an embodiment in which the first conductive housing 310 and the antenna power feeder 341 of the circuit board 340 are electrically connected using the first conductive elastic member 350.

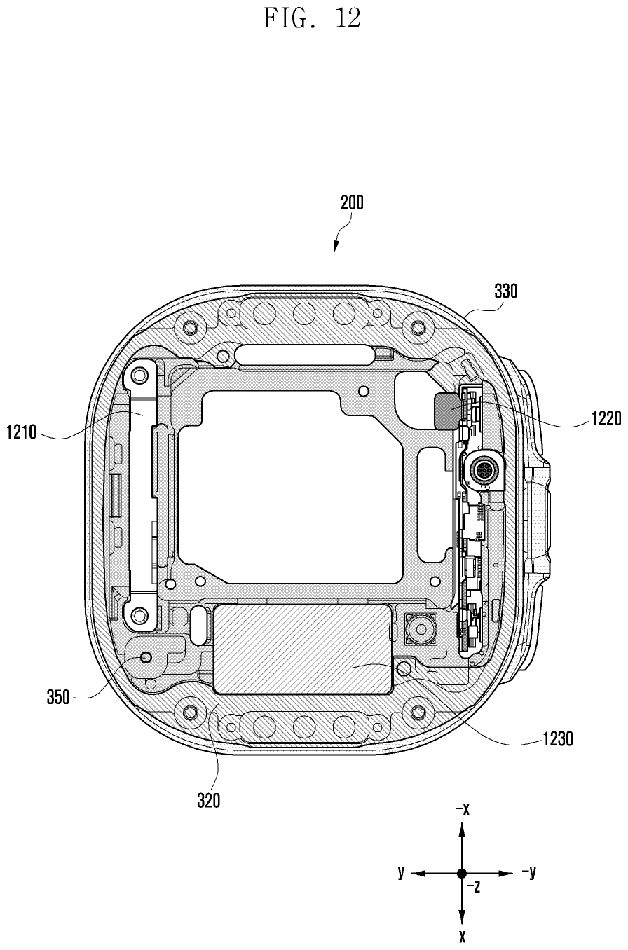

FIG. 12 is a schematic diagram illustrating a partial configuration of a wearable electronic device when viewed from the rear according to an embodiment of the disclosure.

Referring to FIG. 12, the first conductive housing 310 and the antenna power feeder 341 formed on the circuit board 340 may be electrically connected using a first conductive elastic member 350 in the wearable electronic device 200. According to a comparative embodiment, the first conductive housing 310 and the antenna power feeder 341 formed on the circuit board 340 may be electrically connected using a C-clip.

According to an embodiment, if the first conductive housing 310 and the antenna power feeder 341 formed on the circuit board 340 are electrically connected using the first conductive elastic member 350, the first conductive elastic member 350 forming a part of the antenna radiator may be positioned at a distance at which it is less electrically affected by electrical components or electronic components such as the speaker 1210, the FPCB 1220, and/or the motor 1230. According to various embodiments, when the first conductive housing 310 and the antenna power feeder 341 formed on the circuit board 340 are electrically connected using the first conductive elastic member 350, the area where the first conductive elastic member 350 is in contact with the circuit board 340 may be reduced.

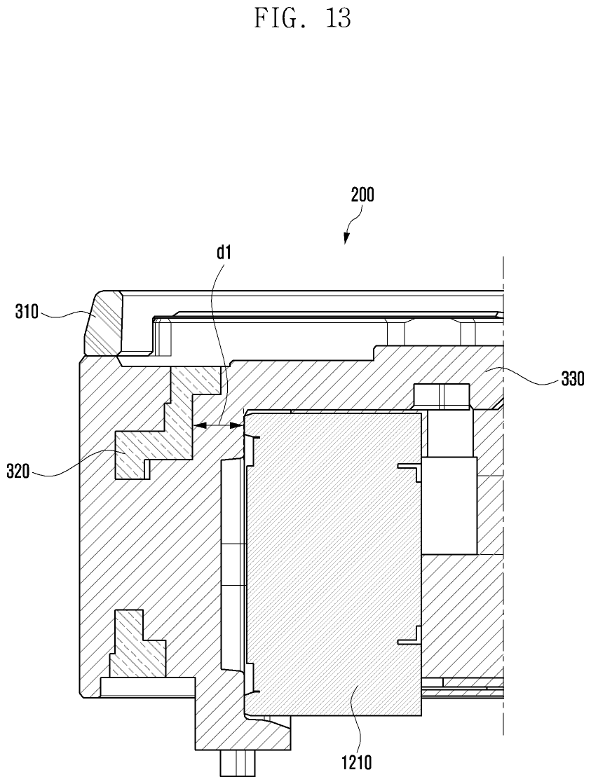

FIG. 13 is a diagram illustrating a distance between a second conductive housing and a speaker of a wearable electronic device according to an embodiment of the disclosure.

Referring to FIG. 13, if the first conductive housing 310 and the antenna power feeder 341 formed on the circuit board 340 form an antenna using the first conductive elastic member 350, a part of the second conductive housing 320 and the speaker 1210 may be spaced apart from each other by a distance d1 of about 0.8 mm to 1.0 mm.

According to a comparative embodiment, if the second conductive housing 320 and the antenna power feeder 341 formed on the circuit board 340 form an antenna using a C-clip, a part of the second conductive housing 320 and the speaker 1210 may not be substantially spaced apart.

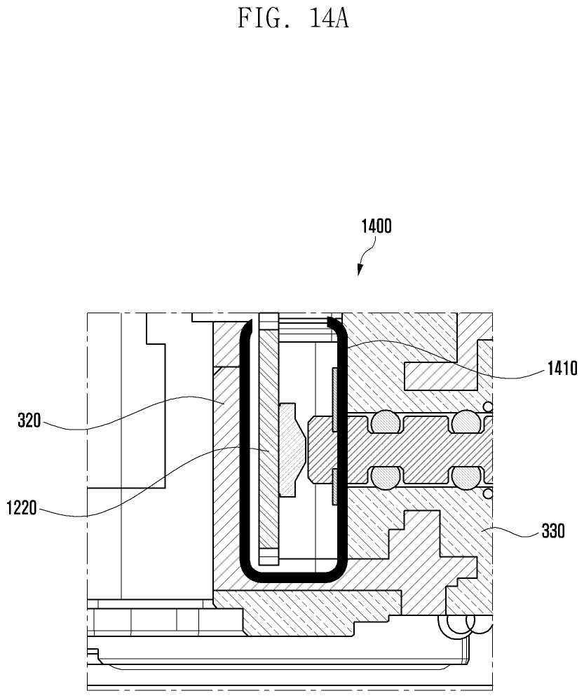

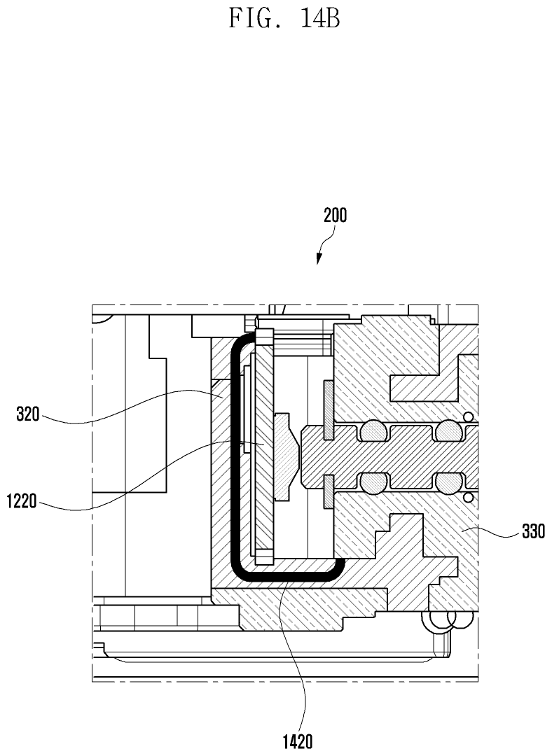

FIG. 14A is a diagram schematically illustrating a portion of a wearable electronic device including an FPCB according to a comparative embodiment. FIG. 14B is a diagram schematically illustrating a portion of a wearable electronic device including an FPCB according to an embodiment of the disclosure.

For example, FIG. 14A may be a drawing schematically illustrating a part of a wearable electronic device 1400 according to a comparative embodiment in which the first conductive housing 310 and the antenna power feeder 341 formed on the circuit board 340 are electrically connected using a C-clip. For example, FIG. 14B may be a drawing schematically illustrating a part of a wearable electronic device 200 according to an embodiment of the disclosure in which the first conductive housing 310 and the antenna power feeder 341 formed on the circuit board 340 are electrically connected using a first conductive elastic member 350.

Referring to FIGS. 14A and 14B, in the case where the first conductive housing 310 and the antenna power feeder 341 formed on the circuit board 340 are electrically connected using a C-clip in the wearable electronic device 1400 according to the comparative embodiment, a first area 1410 of the second conductive housing 320 surrounding the FPCB 1220 may be greater than a second area 1420 of the second conductive housing 320 surrounding the FPCB 1220 in the wearable electronic device 200 according to an embodiment of the disclosure in which the first conductive housing 310 and the antenna power feeder 341 formed on the circuit board 340 are electrically connected using the first conductive elastic member 350.

According to an embodiment, the second area 1420 of the second conductive housing 320 surrounding the FPCB 1220 according to an embodiment of the disclosure may be reduced from about 80% to 84% to about 48% to 52%, compared to the first area 1410 of the second conductive housing 320 surrounding the FPCB 1220 according to the comparative embodiment.

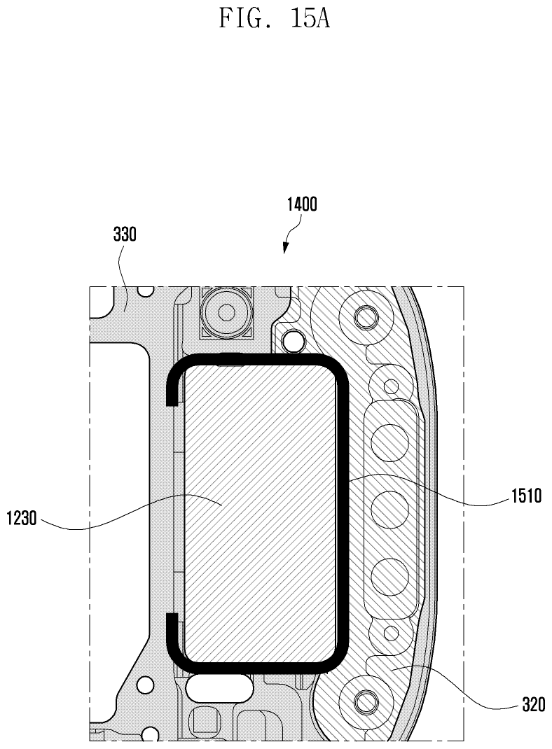

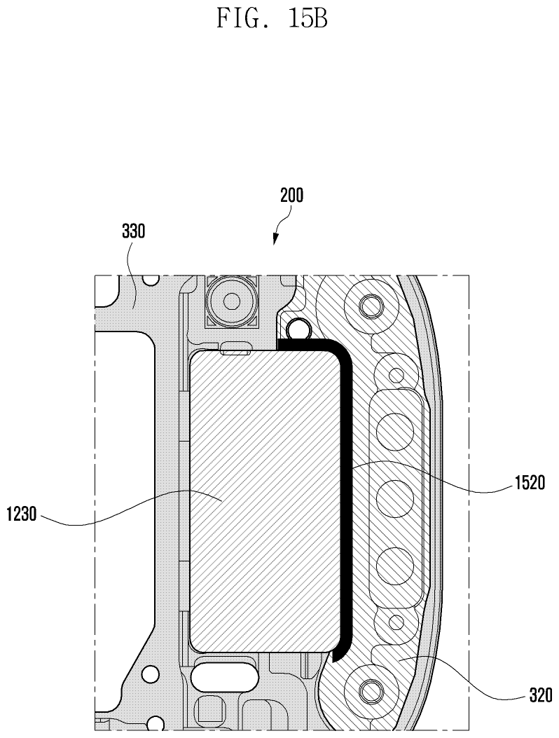

FIG. 15A is a diagram schematically illustrating a portion of a wearable electronic device including a motor according to a comparative example. FIG. 15B is a diagram schematically illustrating a portion of a wearable electronic device including a motor according to an embodiment of the disclosure.

For example, FIG. 15A may be a diagram schematically illustrating a part of a wearable electronic device 1400 according to a comparative embodiment in which the first conductive housing 310 and the antenna power feeder 341 formed on the circuit board 340 are electrically connected using a C-clip. For example, FIG. 15B may be a diagram schematically illustrating a part of a wearable electronic device 200 according to an embodiment of the disclosure in which the first conductive housing 310 and the antenna power feeder 341 formed on the circuit board 340 are electrically connected using a first conductive elastic member 350.

Referring to FIGS. 15A and 15B, in the case where the first conductive housing 310 and the antenna power feeder 341 formed on the circuit board 340 are electrically connected using a C-clip in the wearable electronic device 1400 according to the comparative embodiment, a first area 1510 of the second conductive housing 320 surrounding the motor 1230 may be greater than a second area 1520 of the second conductive housing 320 surrounding the motor 1230 in the wearable electronic device 200 according to an embodiment of the disclosure in which the first conductive housing 310 and the antenna power feeder 341 formed on the circuit board 340 are electrically connected using the first conductive elastic member 350.

According to an embodiment, the second area 1520 of the second conductive housing 320 surrounding the motor 1230 according to an embodiment of the disclosure may be reduced from about 70% to 74% to about 37% to 41%, compared to the first area 1510 of the second conductive housing 320 surrounding the motor 1230 according to the comparative embodiment.

A wearable electronic device 200 according to an embodiment of the disclosure may include a first conductive housing 310 having a first opening 301 and a second conductive housing 320 disposed under the first conductive housing 310. According to an embodiment, the wearable electronic device 200 may include a non-conductive housing 330 surrounding at least a part of the second conductive housing 320 and having a second opening 302 and a third opening 303, and a circuit board 340 disposed under the non-conductive housing 330 and including an antenna power feeder 341. According to an embodiment, the wearable electronic device 200 may include a first conductive elastic member 350 configured to connect the first conductive housing 310 and the antenna power feeder 341 through the second opening 302 and a second conductive elastic member 360 configured to connect the first conductive housing 310 and the second conductive housing 320 through the third opening 303.

According to an embodiment, the wearable electronic device 200 may further include a display 220, and the display 220 may be positioned inside the first opening 301.

According to an embodiment, the first conductive elastic member 350 and the second conductive elastic member 360 may include a pogo pin, and the second conductive elastic member 360 may be shorter in length and thicker in thickness than the first conductive elastic member 350.

According to an embodiment, the second conductive housing 320 may include a fourth opening 304, and the first conductive elastic member 350 may electrically connect the first conductive housing 310 and the antenna power feeder 341 through the second opening 302 and the fourth opening 304.

According to an embodiment, the fourth opening 304 may have a diameter greater than that of the second opening 302, and the second opening 302 may be positioned inside the fourth opening 304.

According to an embodiment, the wearable electronic device 200 may further include a fifth opening 305 formed in the non-conductive housing 330, and a third conductive elastic member 370 configured to electrically connect the first conductive housing 310 and the second conductive housing 320 through the fifth opening 305.

According to an embodiment, a first connecting portion P1 of the first conductive housing 310 connected to the first conductive elastic member 350 may be positioned between a second connecting portion P2 of the first conductive housing 310 connected to the second conductive elastic member 360 and a third connecting portion P3 of the first conductive housing 310 connected to the third conductive elastic member 370.

According to an embodiment, a first distance between the first connecting portion P1 and the second connecting portion P2 may be formed longer than a second distance between the first connecting portion P1 and the third connecting portion P3.

According to an embodiment, the first conductive housing 310 may further include a protrusion 315 at least partially inserted into the second opening 302 of the non-conductive housing 330, and a first sealing member 3505 may be disposed on an outer surface of the protrusion 315.

According to an embodiment, the protrusion 315 may include a first groove 3151 formed at an end, and at least a portion of the first conductive elastic member 350 may be inserted into and connected to the first groove 3151.

According to an embodiment, the first conductive housing 310 may further include a second groove 3152, and at least a part of the second conductive elastic member 360 may be inserted into and connected to the second groove 3152.

According to an embodiment, the circuit board 340 may further include a first grounding part 343G, and a part of the second conductive housing 320 may be connected to the first grounding part 343G.

According to an embodiment, the wearable electronic device 200 may further include a second sealing member 3605 surrounding an outer surface of the second conductive elastic member 360 having at least a portion inserted into the second groove 3152.

According to an embodiment, the first conductive housing 310 may further including a third groove 3153, and at least a portion of the third conductive elastic member 370 may be inserted into and connected to the third groove 3153.

According to an embodiment, the wearable electronic device 200 may further include a third sealing member 3705 surrounding an outer surface of the third conductive elastic member 370 having at least a portion inserted into the third groove 3153.

According to an embodiment, a part of the second conductive housing 320 may be electrically connected to the first grounding part 343G through a first C-clip 343.

According to an embodiment, the circuit board 340 may further include a second grounding part 345G, and another part of the second conductive housing 320 may be electrically connected to the second grounding part 345G through a second C-clip 345.

According to an embodiment, the wearable electronic device 200 may further include a third housing 380 having a sixth opening 381 and disposed on a top of the first conductive housing 310, and the third housing 380 may include at least one cutting area 385.

According to an embodiment, the wearable electronic device 200 may further include a rear plate 207 disposed below the circuit board 340, and a fourth sealing member 390 may be disposed between the non-conductive housing 330 and the rear plate 207.

According to an embodiment, the first conductive elastic member 350 may include a first step 535, and the non-conductive housing 330 may include a second step 335 formed inside the second opening 302, and the first step 535 may be configured to be caught and supported by the second step 335.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Although non-limiting example embodiments of the disclosure have been described above with reference to the accompanying drawings, embodiments of the disclosure encompass changes and modifications made by those skilled in the art to which the disclosure belongs without departing from the spirit and scope of the of the disclosure.

What is claimed is:

1. A wearable electronic device comprising:
a first conductive housing including a first opening;
a second conductive housing under the first conductive housing;
a non-conductive housing surrounding at least a part of the second conductive housing, the non-conductive housing including a second opening and a third opening;
a circuit board under the non-conductive housing and comprising an antenna power feeder;
a first conductive elastic member configured to connect the first conductive housing and the antenna power feeder through the second opening; and
a second conductive elastic member configured to connect the first conductive housing and the second conductive housing through the third opening.

2. The wearable electronic device according to claim 1, further comprising a display,
wherein the display is inside the first opening.

3. The wearable electronic device according to claim 1,
wherein the first conductive elastic member and the second conductive elastic member comprise a pogo pin, and
wherein a length of the second conductive elastic member is shorter than a length of the first conductive elastic member, and a thickness of the second conductive elastic member is larger than a thickness of the first conductive elastic member.

4. The wearable electronic device according to claim 1,
wherein the second conductive housing comprises a fourth opening, and
wherein the first conductive elastic member electrically connects the first conductive housing and the antenna power feeder through the second opening and the fourth opening.

5. The wearable electronic device according to claim 4,
wherein the fourth opening has a diameter greater than a diameter of the second opening, and
wherein the second opening is inside the fourth opening.

6. The wearable electronic device according to claim 1, further comprising:
a fifth opening in the non-conductive housing; and
a third conductive elastic member configured to electrically connect the first conductive housing and the second conductive housing through the fifth opening.

7. The wearable electronic device according to claim 6, wherein
the first conductive housing comprises:
a first connecting portion connected to the first conductive elastic member;
a second connecting portion connected to the second conductive elastic member; and
a third connecting portion connected to the third conductive elastic member,
wherein the first connecting portion is between the second connecting portion and the third connecting portion.

8. The wearable electronic device according to claim 7,
wherein a first distance between the first connecting portion and the second connecting portion is longer than a second distance between the first connecting portion and the third connecting portion.

9. The wearable electronic device according to claim 1,
wherein the first conductive housing comprises a protrusion at least partially in the second opening of the non-conductive housing, and
wherein the wearable electronic device further comprises a first sealing member on an outer surface of the protrusion.

10. The wearable electronic device according to claim 9,
wherein the protrusion comprises a first groove at an end of the protrusion, and
wherein at least a portion of the first conductive elastic member is in and connected to the first groove.

11. The wearable electronic device according to claim 10,
wherein the first conductive housing further comprises a second groove, and
wherein at least a part of the second conductive elastic member is in and connected to the second groove.

12. The wearable electronic device according to claim 1,
wherein the circuit board further comprises a first grounding part, and
wherein the second conductive housing is connected to the first grounding part.

13. The wearable electronic device according to claim 11, further comprising a second sealing member surrounding an outer surface of the second conductive elastic member.

14. The wearable electronic device according to claim 13, further comprising:
a fifth opening in the non-conductive housing; and
a third conductive elastic member configured to electrically connect the first conductive housing and the second conductive housing through the fifth opening,
wherein the first conductive housing further comprises a third groove, and
wherein at least a portion of the third conductive elastic member is in and connected to the third groove.

15. The wearable electronic device according to claim 14, further comprising a third sealing member surrounding an outer surface of the third conductive elastic member.

16. The wearable electronic device according to claim 12,
wherein the second conductive housing is electrically connected to the first grounding part via a first C-clip.

17. The wearable electronic device according to claim 16,
wherein the circuit board further comprises a second grounding part, and
wherein another part of the second conductive housing is electrically connected to the second grounding part via a second C-clip.

18. The wearable electronic device according to claim 1, further comprising a third housing including a sixth opening, the third housing being on a top of the first conductive housing,
wherein the third housing comprises at least one cutting area, the at least one cutting area configured to reduce an influence on radiation performance of the first conductive housing.

19. The wearable electronic device according to claim 1, further comprising:
a rear plate below the circuit board; and
a sealing member between the non-conductive housing and the rear plate.

20. The wearable electronic device according to claim 1,
wherein the first conductive elastic member comprises a first step,
wherein the non-conductive housing comprises a second step inside the second opening, and
wherein the first step is configured to be caught and supported by the second step.
